(19) United States
(12) Patent Application Publication
(10) Pub. No.: US 2019/0379139 A1
(43) Pub. Date: Dec. 12, 2019

(54) WIRELESS COMMUNICATION MODULE

(71) Applicants: Kabushiki Kaisha Toshiba, Tokyo (JP); Toshiba Electronic Devices & Storage Corporation, Tokyo (JP)

(72) Inventors: Minoru Takizawa, Sagamihara Kanagawa (JP); Jia Liu, Yokohama Kanagawa (JP)

(21) Appl. No.: 16/288,359

(22) Filed: Feb. 28, 2019

(30) Foreign Application Priority Data
Jun. 6, 2018 (JP) 2018-109071

(51) Int. Cl. H01Q 21/28; H01Q 1/38; H01Q 1/52

(52) U.S. Cl. CPC H01Q 21/28; H01Q 1/526; H01Q 1/38

(57) ABSTRACT

A wireless communication module according to an embodiment includes: a three-dimensional object having a first face, a second face, a third face, a fourth face, a fifth face, and a sixth face, the three-dimensional object including a resin; a first antenna provided on the first face; a second antenna provided on the second face; a third antenna provided on the third face; a fourth antenna provided on the fourth face; a fifth antenna provided on the fifth face; a sixth antenna provided on the sixth face; and a communication circuit provided in the three-dimensional object, the communication circuit being connected to the first antenna, the second antenna, the third antenna, the fourth antenna, the fifth antenna, or the sixth antenna.

### CROSS-REFERENCE TO RELATED APPLICATION

This application is based upon and claims the benefit of priority from Japanese Patent Application No. 2018-109071, filed on Jun. 6, 2018, the entire contents of which are incorporated herein by reference.

### FIELD

Embodiments described herein relate generally to a wireless communication module.

### BACKGROUND

In recent years, a wireless communication module is used in a wireless communication device with a high-frequency electromagnetic wave (high-frequency signal). The wireless communication module includes, for example, an antenna and a wireless circuit.

The Internet causes a dramatic increase in the amount of information transmission. The market for mobile devices, such as a mobile phone and a tablet computer, has been widespread. Therefore, a wireless communication mobile capable of propagating a larger-capacity signal having a large number of frequencies, is required.

### BRIEF DESCRIPTION OF THE DRAWINGS

FIGS. 1A to 1D are schematic views of a wireless communication module according to a first embodiment;

FIGS. 2A to 2D are schematic views of a wireless communication module according to a second embodiment;

FIGS. 3A to 3D are schematic views of a wireless communication module according to a third embodiment;

FIGS. 4A to 4C are circuit diagrams of matching circuits; and

FIGS. 5A to 5D are schematic views of a wireless communication module according to a fourth embodiment.

### DETAILED DESCRIPTION

Embodiments will be described below with the drawings. Note that the same parts or similar parts are denoted with the same reference signs or similar reference signs in the drawings.

In the present specification, the same members or similar members are denoted with the same reference signs, and the duplicate descriptions will be omitted in some cases.

In the present specification, the upward direction of the drawings is described with “top” and the downward direction of the drawings is described with “bottom”, in order to indicate the positional relationship between components, for example. In the present specification, the concept of “top” and “bottom” does not necessarily mean the terms indicating the relationship with the direction of gravity.

### First Embodiment

A wireless communication module according to the present embodiment includes: a three-dimensional object having a first face, a second face, a third face, a fourth face, a fifth face, and a sixth face, the three-dimensional object including a resin; a first antenna provided on the first face; a second antenna provided on the second face; a third antenna provided on the third face; a fourth antenna provided on the fourth face; a fifth antenna provided on the fifth face; a sixth antenna provided on the sixth face; and a communication circuit provided in the three-dimensional object, the communication circuit being connected to the first antenna, the second antenna, the third antenna, the fourth antenna, the fifth antenna, or the sixth antenna.

A wireless communication module according to the present embodiment includes: a three-dimensional object at least having a first face and a second face, the three-dimensional object including a resin; a first antenna provided on the first face, the first antenna having a first resonance frequency; a second antenna provided on the second face, the second antenna having a second resonance frequency different from the first resonance frequency; and a communication circuit provided in the three-dimensional object, the communication circuit being connected to the first antenna or the second antenna.

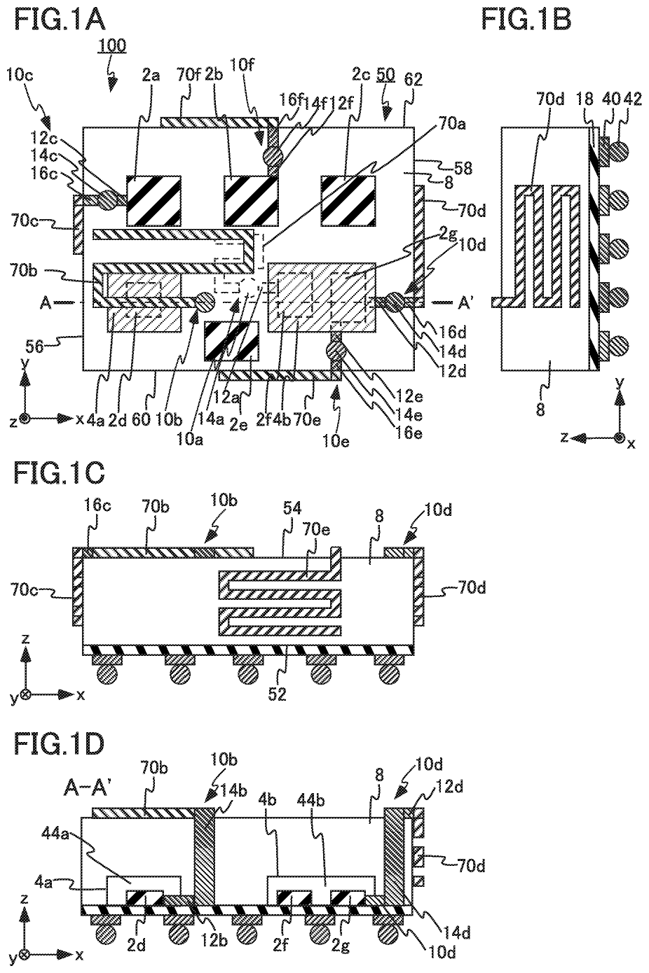

FIGS. 1A to 1D are schematic views of a wireless communication module 100 according to the present embodiment.

Here, an x axis, a y axis perpendicular to the x axis, and a z axis perpendicular to the x axis and the y axis are defined. FIG. 1A is a schematic view of the wireless communication module 100 when viewed in the z direction. FIG. 1B is a schematic view of the wireless communication module 100 when viewed in the x direction. FIG. 1C is a schematic view of the wireless communication module 100 when viewed in the y direction. FIG. 1D is a schematic sectional view of the wireless communication module 100 when viewed in the y direction at section A-A′ illustrated in FIG. 1A. Note that FIG. 1A omits the illustration of a substrate 18 disposed behind the drawing plane.

The wireless communication module 100 includes a three-dimensional object 50, a linear antenna 70, and a communication circuit 2.

The three-dimensional object 50 has a first face 52, a second face 54, a third face 56, a fourth face 58, a fifth face 60, and a sixth face 62.

The three-dimensional object 50 include a resin 8. Here, the resin 8 is, for example, a thermosetting epoxy resin. Furthermore, the three-dimensional object 50 may include, for example, an epoxy resin including a filler formed with silicon oxide or aluminum oxide.

In the wireless communication module 100 illustrated in FIGS. 1A to 1D, the three-dimensional object 50 is cuboid in shape. The first face 52 corresponds to the bottom face of the three-dimensional object 50, and the second face 54 corresponds to the top face of the three-dimensional object 50. The third face 56, the fourth face 58, the fifth face 60, and the sixth face 62 correspond to the side faces of the three-dimensional object 50. Here, the third face 56 and the fourth face 58 face each other, and the fifth face 60 and the sixth face 62 face each other. Note that the three-dimensional object 50 is not limited to being cuboid in shape. The three-dimensional object 50 may be further provided with another face. Furthermore, the shape of the three-dimensional object 50 may be, for example, a triangular pyramid or a cylinder. Needless to say, for example, an elliptical shape or a spherical shape can be molded with the resin 8 regardless of the shape of the communication circuit 2.

A face of the three-dimensional object 50, for example, the first face 52 is provided with the substrate 18. The substrate 18 is, for example, a glass epoxy substrate.

The wireless communication module 100 according to the present embodiment includes the linear antenna 70 as an antenna. Specifically, a first antenna 70a as the linear antenna 70 is provided on the first face 52. A second antenna 70b as the linear antenna is provided on the second face 54. A third antenna 70c as the linear antenna is provided on the third face 56. A fourth antenna 70d as the linear antenna is provided on the fourth face 58. A fifth antenna 70e as the linear antenna is provided on the fifth face 60. A sixth antenna 70f as the linear antenna is provided on the sixth face 62.

Here, “a predetermined antenna is provided on a predetermined face” includes that the predetermined antenna is provided on the surface of the predetermined face and that the predetermined antenna is provided in proximity to the predetermined face inside the three-dimensional object 50. For example, a case where part of the predetermined antenna is provided inside the three-dimensional object 50 and part of the predetermined antenna protrudes from the predetermined face, is included.

Examples of the linear antenna 70 include a spiral antenna, a meander antenna, and a straight-line antenna like a dipole antenna. In the wireless communication module 100 according to the present embodiment, the first antenna 70a, the second antenna 70b, the third antenna 70c, the fourth antenna 70d, the fifth antenna 70e, and the sixth antenna 70f each are a meander antenna.

Favorably, the first resonance frequency of the first antenna 70a, the second resonance frequency of the second antenna 70b, the third resonance frequency of the third antenna 70c, the fourth resonance frequency of the fourth antenna 70d, the fifth resonance frequency of the fifth antenna 70e, and the sixth resonance frequency of the sixth antenna 70f are different from each other. Note that the first resonance frequency, the second resonance frequency, the third resonance frequency, the fourth resonance frequency, the fifth resonance frequency, and the sixth resonance frequency all may be identical. For example, the first resonance frequency and the second resonance frequency may be identical, and the third resonance frequency, the fourth resonance frequency, the fifth resonance frequency, and the sixth resonance frequency may be different from the first resonance frequency and the second resonance frequency.

In the wireless communication module 100 according to the present embodiment, the first antenna 70a is provided as a wired line formed on the surface of the substrate 18 inside the resin 8, in proximity to the first face 52. The second antenna 70b is formed on the surface of the second face 54. The third antenna 70c is formed on the surface of the third face 56. The fourth antenna 70d is formed on the surface of the fourth face 58. The fifth antenna 70e is formed on the surface of the fifth face 60. The sixth antenna 70f is formed on the surface of the sixth face 62.

As the communication circuit 2, provided are a first communication circuit 2a, a second communication circuit 2b, a third communication circuit 2c, a fourth communication circuit 2d, a fifth communication circuit 2e, a sixth communication circuit 2f, and a seventh communication circuit 2g implemented on the surface (substrate face) of the substrate 18 inside the resin 8.

The communication circuit 2 is, for example, an electronic circuit. The communication circuit 2 includes a computer including hardware, such as an electronic circuit to be used for communication, or a combination of hardware, such as an electronic circuit to be used for communication, and software, such as a program, the computer being sealed with resin, such as a sealing resin. The communication circuit 2 includes, for example, a computer including a combination of hardware and software, such as a program. Here, the program stored in a recording medium, such as a flash memory, is sealed together with the electronic circuit.

Note that the communication circuit 2 is not necessarily implemented on the surface of the substrate 18. For example, the communication circuit 2 spaced apart from the surface of the substrate 18 may be sealed inside the resin 8.

As a shielding case 4, provided are a first shielding case 4a and a second shielding case 4b fixed on the surface (substrate face) of the substrate 18 inside the resin 8.

Specifically, the fourth communication circuit 2d is covered with the first shielding case 4a. The first shielding case 4a has a space 44a inside. Part of the first shielding case 4a is connectable to a ground, for example, through a wired line, not illustrated, provided at the substrate 18.

The sixth communication circuit 2f and the seventh communication circuit 2g are covered with the second shielding case 4b. The second shielding case 4b has a space 44b inside. Part of the second shielding case 4b is connectable to the ground, for example, through a wired line, not illustrated, provided at the substrate 18.

In the wireless communication module 100 according to the present embodiment, as illustrated in FIG. 1D, the second antenna 70b, the resin 8, the first shielding case 4a, the space 44a, the fourth communication circuit 2d, and the substrate 18 are disposed in this order parallel in the z direction.

The first antenna 70a is connected to the sixth communication circuit 2f through a first transmission line 10a as a transmission line 10. The first transmission line 10a has: a first wired line 12a connected to the sixth communication circuit 2f; and a via 14a connecting the first wired line 12a and the first antenna 70a.

The second antenna 70b is connected to the fourth communication circuit 2d through a second transmission line 10b as the transmission line 10. The second transmission line 10b has: a first wired line 12b connected to the fourth communication circuit 2d; and a via 14b connecting the second antenna 70b and the first wired line 12b.

The third antenna 70c is connected to the first communication circuit 2a through a third transmission line 10c as the transmission line 10. The third transmission line 10c has: a first wired line 12c connected to the first communication circuit 2a; a second wired line 16c connected to the third antenna 70c; and a via 14c connecting the first wired line 12c and the second wired line 16c.

The fourth antenna 70d is connected to the seventh communication circuit 2g through a fourth transmission line 10d as the transmission line 10. The fourth transmission line 10d has: a first wired line 12d connected to the seventh communication circuit 2g; a second wired line 16d connected to the fourth antenna 70d; and a via 14d connecting the first wired line 12d and the second wired line 16d.

The fifth antenna 70e is connected to the seventh communication circuit 2g through a fifth transmission line 10e as the transmission line 10. The fifth transmission line 10e has: a first wired line 12e connected to the seventh communication circuit 2g; a second wired line 16e connected to the fifth antenna 70e; and a via 14e connecting the first wired line 12e and the second wired line 16e.

The sixth antenna 70f is connected to the second communication circuit 2b through a sixth transmission line 10f as the transmission line 10. The sixth transmission line 10f has: a first wired line 12f connected to the second communication circuit 2b; a second wired line 16f connected to the sixth antenna 70f; and a via 14f connecting the first wired line 12f and the second wired line 16f.

Favorably, the first wired line 12 and the second wired line 16 each are a wired line through which a high-frequency signal can be transmitted, such as a microstrip line or a coplanar waveguide. Note that the illustration of the ground used for the microstrip line or the coplanar waveguide is omitted.

The communication circuit 2 may support a single frequency or may support a plurality of frequencies. For example, the seventh communication circuit 2g is capable of transmitting and receiving a radio wave having the fourth resonance frequency and a radio wave having the fifth resonance frequency with the fourth antenna 70d and the fifth antenna 70e. In a case where the fourth resonance frequency and the fifth resonance frequency are identical, the seventh communication circuit 2g is required at least to support transmission and reception of a single frequency (fourth resonance frequency or fifth resonance frequency). Meanwhile, in a case where the fourth resonance frequency is different from the fifth resonance frequency, the seventh communication circuit 2g is required at least to enable transmission and reception of a radio wave having the fourth resonance frequency and a radio wave having the fifth resonance frequency that are different from each other.

In a case where the first resonance frequency, the second resonance frequency, the third resonance frequency, the fourth resonance frequency, the fifth resonance frequency, and the sixth resonance frequency are different from each other, favorably, each communication circuit 2 supports transmission and reception of a radio wave having the frequency different from the others.

A plurality of electrodes 40 formed with, for example, copper (Cu), is provided on the face opposite to the face on which the resin 8 is provided, of the substrate 18, the electrodes 40 being bonded to the substrate 18. Provided are respective solder balls 42 joined to the electrodes 40. The wireless communication module 100 is implemented onto a circuit board of a wireless communication device not illustrated, through the solder balls 42. Note that an implementation method for the wireless communication module 100 is not limited to the above.

Note that the wireless communication module 100 according to the present embodiment is provided with the first antenna 70a, the second antenna 70b, the third antenna 70c, the fourth antenna 70d, the fifth antenna 70e, and the sixth antenna 70f. However, all the six antennas are not necessarily used in accordance with a use or a communication function. For example, provided may be a wireless communication module including the first antenna 70a, the second antenna 70b, the third antenna 70c, the fourth antenna 70d, and the fifth antenna 70e with the sixth face 62 provided with no sixth antenna 70f.

As an exemplary method of manufacturing the wireless communication module 100 according to the present embodiment, the first communication circuit 2a, the second communication circuit 2b, the third communication circuit 2c, the fourth communication circuit 2d, the fifth communication circuit 2e, the sixth communication circuit 2f, and the seventh communication circuit 2g are implemented onto the surface of the substrate 18 having the electrodes 40. Next, the fourth communication circuit 2d is covered with the first shielding case 4a, and the sixth communication circuit 2f and the seventh communication circuit 2g are covered with the second shielding case 4b. Next, the surface of the substrate 18 is sealed with the resin, and then the linear antenna 70 and the transmission line 10 are formed. Next, the solder balls 42 are formed on the surfaces of the electrodes 40, and then the wireless communication module 100 according to the present embodiment is acquired.

Here, after formation of an antenna pattern and a hole that can be rendered in microscopically roughening, to the resin 8 with laser irradiation, the linear antenna 70 and the via 14 can be formed with, for example, electroless plating.

Next, a functional effect according to the present embodiment will be described.

Conventionally, in a case where a mobile communication terminal device or a data transmission device is made such that radio waves having a plurality of frequencies can be transmitted and received, a design for arranging isolation from peripheral circuitry on a substrate and a circuit design for reducing transmission loss are made individually every device. Therefore, a lot of time and effort are required in design.

For example, in a case where it is found that a fault is present in inspection of a block of a wireless communication module for transmission and reception of a specific frequency, analysis of a faulty component and re-designing are required for the block. However, for example, like a fault in a block supporting a frequency of a few hundred MHz, results from the shape of the ground plane of a block supporting a frequency of 2.4 GHz, a fault in a specific block results from the design of another block. Therefore, analysis of a part at which a fault has occurred and re-designing require a lot of time and effort.

For a wireless communication module capable of transmitting and receiving a plurality of frequencies, in a case where a plurality of antennas is disposed on the same face in the wireless communication module, there is a drawback that mutual interference between the antennas causes a communication failure. Furthermore, there is a drawback that a communication failure occurs due to mutual interference between blocks, for example, through a ground plane.

An antenna characteristic, such as the directivity of an antenna, varies due to metal disposed around the antenna in a mobile communication terminal device or a data transmission device. Therefore, there is a problem that the disposition of an antenna is limitative in a wireless communication module.

Furthermore, in a case where transmission and reception are performed at a particularly high frequency, because the wavelength is short and the antenna is small, the antenna characteristic varies more sensitively due to, for example, the shape of a ground, the influence of a metal conductor around the antenna, the shape of a via, and a connection status. Therefore, it is difficult to improve the characteristics of a plurality of antennas with optimization of the above points and disposition of the antennas for acquisition of high directivity.

The wireless communication module 100 according to the present embodiment, includes the three-dimensional object 50 having the first face 52, the second face 54, the third face 56, the fourth face 58, the fifth face 60, and the sixth face 62, the three-dimensional object 50 including the resin 8. The first face 52, the second face 54, the third face 56, the fourth face 58, the fifth face 60, and the sixth face 62 are provided with the first antenna 70a, the second antenna 70b, the third antenna 70c, the fourth antenna 70d, the fifth antenna 70e, and the sixth antenna 70f, respectively. The communication circuit connected to the first antenna 70a, the second antenna 70b, the third antenna 70c, the fourth antenna 70d, the fifth antenna 70e, or the sixth antenna 70f, is provided in the three-dimensional object 50.

This arrangement enables provision of the antennas onto the different faces of the three-dimensional object 50. Therefore, mutual interference between the antennas can be inhibited. This arrangement allows stability of respective radio waves to be transmitted or received through the antennas. Thus, the wireless communication module having a stable operation characteristic, can be provided.

An increase in the degree of freedom for the dispositions of the antennas or transmission-line design, facilitates improvement of the directivity of each antenna. Furthermore, because the mutual interference between the antennas is inhibited, the necessity of considering the design for another antenna decreases in re-designing in a case where a fault has occurred. Therefore, the re-designing is facilitated.

In a case where the first resonance frequency, the second resonance frequency, the third resonance frequency, the fourth resonance frequency, the fifth resonance frequency, and the sixth resonance frequency are different from each other, transmission and reception of radio waves having the six different types of frequencies can be performed. Therefore, downsizing of the wireless communication module and a mobile communication terminal device or a data transmission device having the wireless communication module, becomes easier.

In a case where the first resonance frequency, the second resonance frequency, the third resonance frequency, the fourth resonance frequency, the fifth resonance frequency, and the sixth resonance frequency are the same, transmission and reception of radio waves having the same frequency can be performed in the six directions in total. That is, the wireless communication module including the antennas having considerably high directivity, can be provided. Furthermore, performance of transmission and reception of radio waves with the six antennas in total, enables significant improvement of the communication performance (e.g., communication rate and communication range).

In a case where the shielding case 4 is provided, radio waves to be transmitted or received through the antennas are shielded by not only the resin 8 but also the shielding case 4. Thus, the wireless communication module having a more stable operation characteristic, can be provided. Therefore, even when the second antenna 70b, the resin 8, the first shielding case 4a, the space 44a, the fourth communication circuit 2d, and the substrate 18 are disposed in this order in the z direction as in the wireless communication module according to the present embodiment, a possibility is significantly low that a radio wave to be transmitted or received through the second antenna 70b exerts a bad influence on the operation of the fourth communication circuit 2d.

As described above, the wireless communication module 100 according to the present embodiment enables provision of the wireless communication module having a stable operation characteristic.

### Second Embodiment

A wireless communication module 110 according to the present embodiment is different from that according to the first embodiment in terms of including a planar antenna. Here, the descriptions of duplicate points with respect to the first embodiment will be omitted.

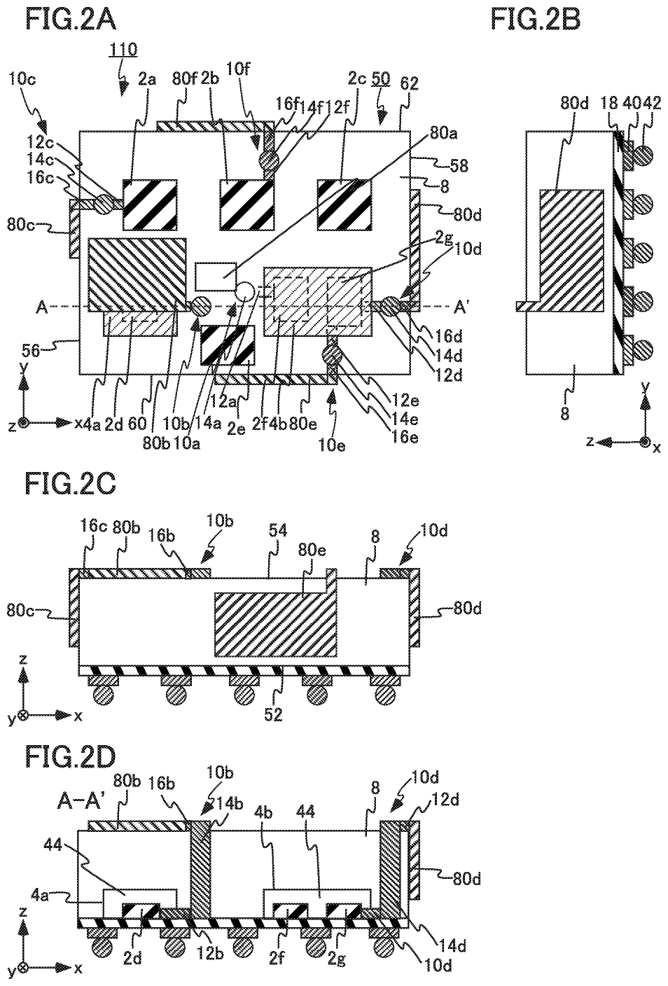

FIGS. 2A to 2D are schematic views of the wireless communication module 110 according to the present embodiment.

A first antenna 80a, a second antenna 80b, a third antenna 80c, a fourth antenna 80d, a fifth antenna 80e, and a sixth antenna 80f each are the planar antenna. Here, the planar antenna is, for example, a patch antenna.

The wireless communication module 110 according to the present embodiment, enables provision of the wireless communication module having a stable operation characteristic.

### Third Embodiment

A wireless communication module 120 according to the present embodiment is different from those according to the first and second embodiments in terms of including a chip antenna. Here, the descriptions of duplicate points with respect to the first and second embodiments will be omitted.

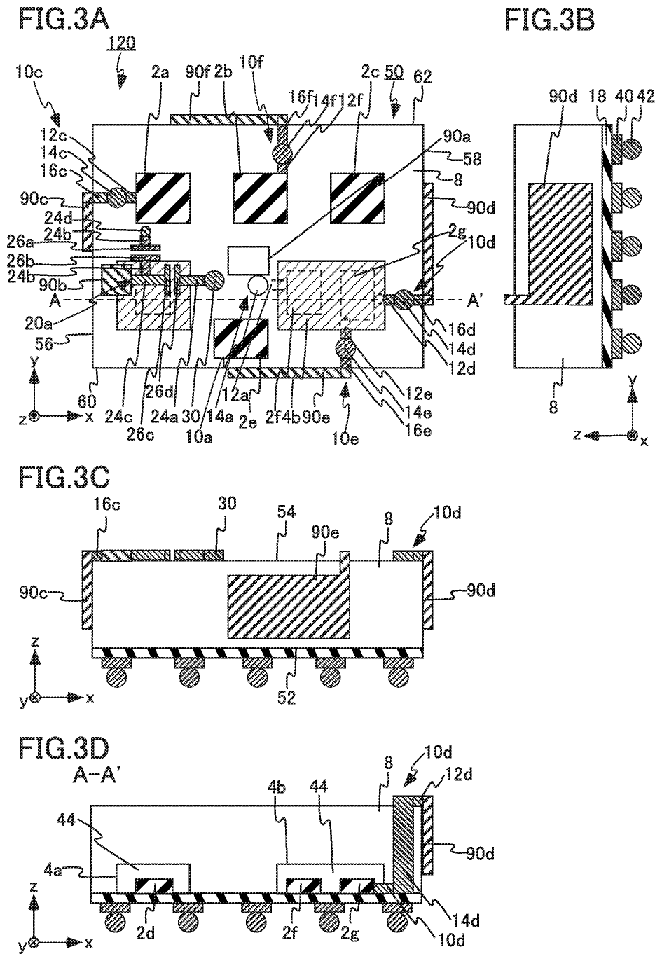

FIGS. 3A to 3D are schematic views of the wireless communication module 120 according to the present embodiment.

A first antenna 90a, a second antenna 90b, a third antenna 90c, a fourth antenna 90d, a fifth antenna 90e, and a sixth antenna 90f each are the chip antenna.

The wireless communication module 120 includes a matching circuit 20.

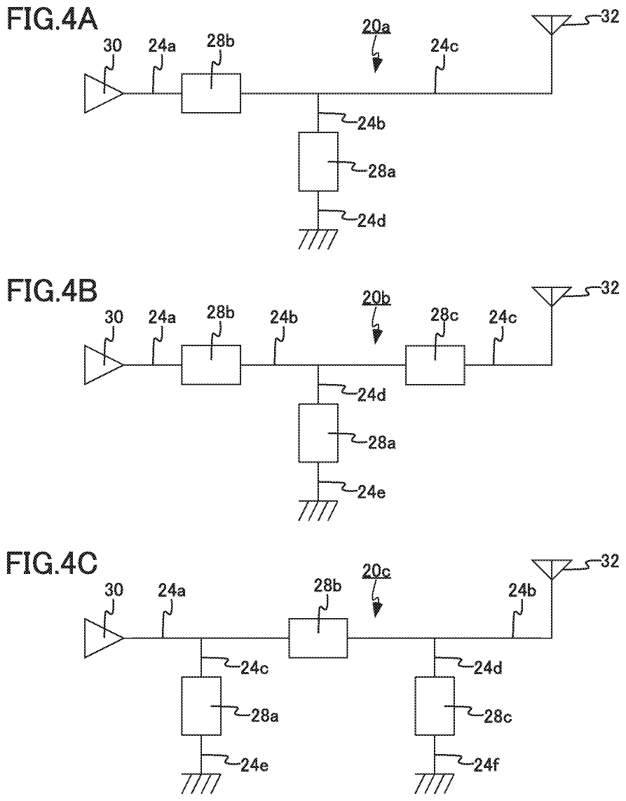

FIGS. 4A to 4C are circuit diagrams of the matching circuit 20. The matching circuit 20 is used for impedance matching, for example.

FIG. 4A is a circuit diagram of an L-type matching circuit 20a that is one type of the matching circuit 20. A signal source 30 and an element 28b are connected through a wired line 24a. The element 28b and an antenna 32 are connected through a wired line 24c. An element 28a and the wired line 24c are connected through a wired line 24b. The element 28a and a ground are connected through a wired line 24d. The antenna 32 is any of the antennas according to the present embodiment.

The wireless communication module 120 illustrated in FIGS. 3A to 3D, includes the L-type matching circuit 20a. The wired line 24d is a ground via for connection to the ground. A pad 26a and a pad 26b are for implementation of the element 28a. A pad 26c and a pad 26d are for implementation of the element 28b.

Note that another matching circuit can be used favorably. For example, a T-type matching circuit or a n-type matching circuit can be used. FIG. 4B is a circuit diagram of a T-type matching circuit 20b that is one type of the matching circuit 20. A signal source 30 and an element 28b are connected through a wired line 24a. The element 28b and an element 28c are connected through a wired line 24b. The element 28c and an antenna 32 is connected through a wired line 24c. An element 28a and the wired line 24b are connected through a wired line 24d. The element 28a and a ground are connected through a wired line 24e.

FIG. 4C is a circuit diagram of a n-type matching circuit 20c that is one type of the matching circuit 20. A signal source 30 and an element 28b are connected through a wired line 24a. The wired line 24a and an element 28a are connected through a wired line 24c. The element 28a and a ground are connected through a wired line 24e. The element 28b and an antenna 32 are connected through a wired line 24b. An element 28c and the wired line 24b are connected through a wired line 24d. The element 28c and the ground are connected through a wired line 24f.

The element 28a, the element 28b, and the element 28c each are a capacitor or an inductor.

Note that, needless to say, the matching circuit 20 illustrated in FIGS. 4A to 4C is favorably used in the first embodiment and the second embodiment.

The wireless communication module 120 according to the present embodiment, enables provision of the wireless communication module having a stable operation characteristic.

### Fourth Embodiment

A wireless communication module 130 according to the present embodiment is different from those according to the first to third embodiments in terms of including a linear antenna, a planar antenna, and a chip antenna. The wireless communication module 130 according to the present embodiment is different from those according to the first to third embodiments in that the face of a substrate 18 in a resin 8 is provided with a seventh antenna that is the chip antenna. Here, the descriptions of duplicate points with respect to the first to third embodiments will be omitted.

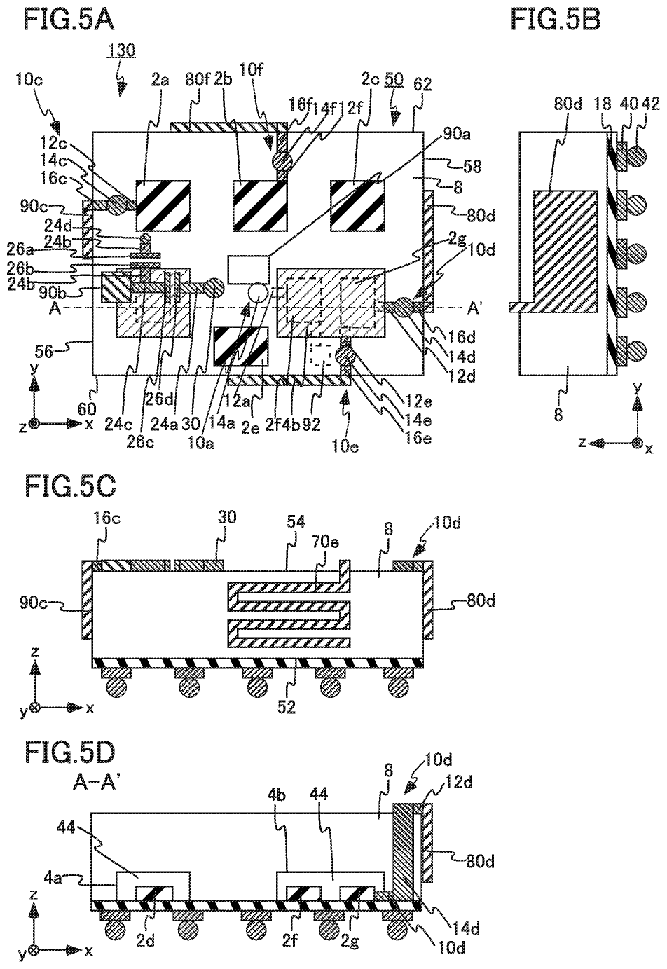

FIGS. 5A to 5D are schematic views of the wireless communication module 130 according to a fourth embodiment.

As a first antenna, a second antenna, a third antenna, a fourth antenna, a fifth antenna, and a sixth antenna, various antennas can be used in accordance with a purpose or a use. The wireless communication module 130 includes a first antenna 90a that is the chip antenna, a second antenna 90b that is the chip antenna, a third antenna 90c that is the chip antenna, a fourth antenna 80d that is the planar antenna, a fifth antenna 70e that is a meander antenna, and a sixth antenna 80f that is the planar antenna.

The seventh antenna (chip antenna) 92 provided on the face of the substrate 18, is connected to a sixth communication circuit 2f. Because the chip antenna is easily implemented onto the surface of the substrate, a plurality of chip antennas (chip antenna 90a and chip antenna 92) can be provided on the surface of the substrate.

The wireless communication module 130 according to the present embodiment, enables provision of the wireless communication module having a stable operation characteristic.

While certain embodiments have been described, these embodiments have been presented by way of example only, and are not intended to limit the scope of the inventions. Indeed, a wireless communication module described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A wireless communication module comprising:
a three-dimensional object at least having a first face and a second face, the three-dimensional object including a resin;
a first antenna provided on the first face, the first antenna having a first resonance frequency;
a second antenna provided on the second face, the second antenna having a second resonance frequency different from the first resonance frequency; and
a communication circuit provided in the three-dimensional object, the communication circuit being connected to the first antenna or the second antenna.

2. The wireless communication module according to claim 1, wherein the first antenna or the second antenna is a linear antenna, a planar antenna, or a chip antenna.

3. The wireless communication module according to claim 1, further comprising: a substrate on the first face or the second face,
wherein the three-dimensional object is cuboid in shape.

4. The wireless communication module according to claim 3, further comprising: a shielding case provided on a substrate face in the resin,
wherein the communication circuit is implemented on the substrate face, the communication circuit being covered with the shielding case.

5. The wireless communication module according to claim 4, wherein
the resin is provided between the first antenna or the second antenna and the substrate,
the shielding case is provided between the resin and the substrate, and
the communication circuit is provided between the shielding case and the substrate.

6. The wireless communication module according to claim 4, further comprising: a third antenna provided on the substrate face in the resin,
wherein the third antenna is a chip antenna.

7. The wireless communication module according to claim 1, wherein the first antenna or the second antenna and the communication circuit are connected through a via.

8. The wireless communication module according to claim 7, wherein the via and the first antenna or the second antenna are formed with electroless plating after formation of an antenna pattern and a hole that are capable of being rendered in microscopically roughening, to the resin.

9. The wireless communication module according to claim 1, further comprising:
a signal source; and
a matching circuit connecting the signal source and the first antenna or the second antenna.

10. The wireless communication module according to claim 9, wherein the matching circuit is an L-type matching circuit, a T-type matching circuit, or a n-type matching circuit.

11. A wireless communication module comprising:
a three-dimensional object having a first face, a second face, a third face, a fourth face, a fifth face, and a sixth face, the three-dimensional object including a resin;
a first antenna provided on the first face;
a second antenna provided on the second face;
a third antenna provided on the third face;
a fourth antenna provided on the fourth face;
a fifth antenna provided on the fifth face;
a sixth antenna provided on the sixth face; and
a communication circuit provided in the three-dimensional object, the communication circuit being connected to the first antenna, the second antenna, the third antenna, the fourth antenna, the fifth antenna, or the sixth antenna.

12. The wireless communication module according to claim 11, wherein a first resonance frequency of the first antenna, a second resonance frequency of the second antenna, a third resonance frequency of the third antenna, a fourth resonance frequency of the fourth antenna, a fifth resonance frequency of the fifth antenna, and a sixth resonance frequency of the sixth antenna are different from each other.

13. The wireless communication module according to claim 11, wherein the first antenna, the second antenna, the third antenna, the fourth antenna, the fifth antenna, or the sixth antenna is a linear antenna, a planar antenna, or a chip antenna.

14. The wireless communication module according to claim 11, further comprising: a substrate on any face of the first face, the second face, the third face, the fourth face, the fifth face, or the sixth face,
wherein the three-dimensional object is cuboid in shape.

15. The wireless communication module according to claim 14, further comprising: a shielding case provided on a substrate face in the resin,
wherein the communication circuit is implemented on the substrate face, the communication circuit being covered with the shielding case.

16. The wireless communication module according to claim 15, wherein
the resin is provided between the first antenna, the second antenna, the third antenna, the fourth antenna, the fifth antenna, or the sixth antenna and the substrate,
the shielding case is provided between the resin and the substrate, and
the communication circuit is provided between the shielding case and the substrate.

17. The wireless communication module according to claim 15, further comprising: a seventh antenna provided on the substrate face in the resin,
wherein the seventh antenna is a chip antenna.

18. The wireless communication module according to claim 11, wherein the communication circuit is capable of transmitting and receiving a plurality of radio waves having respective different frequencies.

19. The wireless communication module according to claim 11, wherein the first antenna, the second antenna, the third antenna, the fourth antenna, the fifth antenna, or the sixth antenna and the communication circuit are connected through a via.

20. The wireless communication module according to claim 19, wherein the via and the first antenna, the second antenna, the third antenna, the fourth antenna, the fifth antenna, or the sixth antenna are formed with electroless plating after formation of an antenna pattern and a hole that are capable of being rendered in microscopically roughening, to the resin.
